(19) United States
(12) Patent Application Publication
(10) Pub. No.: US 2011/0140769 A1
(43) Pub. Date: Jun. 16, 2011

(54) CIRCUIT FOR GENERATING A REFERENCE ELECTRICAL QUANTITY

(75) Inventors: Andrea Visconti, Varese (IT); Paolo Angelini, Bologna (IT)

(73) Assignee: STMicroelectronics S.r.I., Agrate Brianza (MI) (IT)

(21) Appl. No.: 12/965,500

(22) Filed: Dec. 10, 2010

(30) Foreign Application Priority Data
Dec. 11, 2009 (IT) TO2009A000977

(51) Int. Cl. G05F 1/10

(52) U.S. Cl. 327/543

(57) ABSTRACT

A circuit for generating a reference electrical quantity, including: a first bipolar transistor and a second bipolar transistor having the base terminals connected to one another and to a common node; a first resistor connected to the emitter terminal of the second bipolar transistor; a first mirror circuit and a second mirror circuit connected to the first and second bipolar transistors, which receive, respectively, a first current and a second current and generate, respectively, a first mirrored current and a second mirrored current; a first output stage, which generates the reference electrical quantity as a function of the first and second mirrored currents; and a second resistor connected to the common node. The first current is a function of the current in the first resistor, whilst the second current is a function of the current in the second resistor.

### CROSS REFERENCE TO RELATED APPLICATIONS

This application claims the priority benefit of Italian patent application number TO2009A000977, filed on Dec. 11, 2009, entitled “Circuit for Generating a Reference Electrical Quantity,” which is hereby incorporated by reference to the maximum extent allowable by law.

### BACKGROUND OF THE INVENTION

1. Field of the Invention

The present invention relates to a circuit for generating a reference electrical quantity.

2. Discussion of the Related Art

As is known, the majority of electronic devices requires a respective current source, which should be able to supply a reference current as constant as possible in regard to the temperature shifts and to variations in the supply voltage of the electronic devices themselves. In fact, the more the reference current supplied by a current source is stable, the more the overall performance of the electronic device that uses said reference current is stable.

Likewise, it should be noted that numerous electronic devices necessitate a reference voltage, which must also be as constant as possible in regard to temperature shifts and to variations in the supply voltage. For this purpose, various types of reference-voltage sources are known, such as for instance the so-called “bandgap circuits”, which are able to deliver a reference voltage generally close to 1.22 V.

In particular, circuits are known that, in order to reduce the dependence upon temperature, generate a reference current and/or a reference voltage on the basis of a current I_{PTAT} and a current I_{NTAT}. In detail, the current I_{PTAT} is generated so as to be directly proportional to the temperature with a positive temperature coefficient, whereas the current I_{NTAT} is generated so as to be proportional to the temperature, but with a negative temperature coefficient.

By way of example, FIG. 1 shows a voltage and current generator circuit 1, which enables generation of both the reference current and the reference voltage. Said voltage and current generator circuit 1 comprises a first self-biasing circuit 2 and a second self-biasing circuit 4 and moreover comprises a voltage output stage 6 and a current output stage 8. The first self-biasing circuit 2 and the second self-biasing circuit 4, as likewise the voltage output stage 6 and the current output stage 8, are connected between a supply terminal N_{DD}, which can be appropriately connected to a supply voltage V_{DD}, and ground.

In greater detail, the first self-biasing circuit 2 comprises a first biasing transistor T₁ and a second biasing transistor T₂, of a P-channel MOS type, which are connected to form a first current mirror. In particular, the source terminals of the first and second biasing transistors T₁, T₂ are connected to the supply terminal N_{DD}, whilst the gate terminals of the first and second biasing transistors T₁, T₂ are connected to one another; moreover, the second biasing transistor T₂ is diode-connected; i.e., it has its drain terminal connected to its gate terminal. In what follows, to indicate the gate terminals of the first and second biasing transistors T₁, T₂ reference is made to the node N_{PTAT}.

The first self-biasing circuit 2 further comprises a first resistor R_{A} and a first bipolar transistor T_{bjt1} and a second bipolar transistor T_{bjt2}.

In particular, in the example shown in FIG. 1, the first and second bipolar transistors T_{bjt1}, T_{bjt2} are of an npn type. The collector terminals of the first and second bipolar transistors T_{bjt1}, T_{bjt2} are connected, respectively, to the drain terminals of the first and second biasing transistors T₁, T₂. In addition, the base terminals of the first and second bipolar transistors T_{bjt1}, T_{bjt2} are connected to one another, and the first bipolar transistor T_{bjt1} is diode-connected; i.e., it has its respective base terminal connected to its respective collector terminal. Again, the emitter terminal of the first bipolar transistor T_{bjt1} is connected to ground, whilst the emitter terminal of the second bipolar transistor T_{bjt2} is connected to the first resistor R_{A}, which is moreover connected to ground.

The second self-biasing circuit 4 comprises a third biasing transistor T₃ and a fourth biasing transistor T₄ of a P-channel MOS type, which are connected to form a second current mirror. In particular, the source terminals of the third and fourth biasing transistors T₃, T₄ are connected to the supply terminal N_{DD}, whilst the gate terminals of the third and fourth biasing transistors T₃, T₄ are connected to one another; moreover, the fourth biasing transistor T₄ is diode-connected. In what follows, to indicate the gate terminals of the third and fourth biasing transistors T₃, T₄ reference is made to the node N_{NTAT}.

The second self-biasing circuit 4 further comprises a second resistor R_{B}, a third bipolar transistor T_{bjt3}, and a fifth biasing transistor T₅. In particular, the fifth biasing transistor T₅ is of an N-channel MOS type; moreover, in the example shown in FIG. 1, the third bipolar transistor T_{bjt3} is of an npn type.

The drain terminal of the fifth biasing transistor T₅ is connected to the drain terminal (and hence also to the gate terminal) of the fourth biasing transistor T₄. Instead, the gate terminal and the source terminal of the fifth biasing transistor T₅ are connected, respectively, to the drain terminal of the third biasing transistor T₃ and to the base terminal of the third bipolar transistor T_{bjt3}.

In addition, the collector terminal of the third bipolar transistor T_{bjt3} is connected to the drain terminal of the third biasing transistor T₃ and hence also to the gate terminal of the fifth biasing transistor T₅, whilst the emitter terminal of the third bipolar transistor T_{bjt3} is connected to ground. Finally, the second resistor R_{B} is connected between ground and the base terminal of the third bipolar transistor T_{bjt3}.

The voltage output stage 6 comprises an output resistor R_{OUT} and a first sum transistor Tₛ₁ and a second sum transistor Tₛ₂, both of a P-channel MOS type. The source terminals of said first and second sum transistors Tₛ₁, Tₛ₂ are connected to the supply terminal N_{DD}, whilst the gate terminals are connected, respectively, to the node N_{NTAT} and to the node N_{NTAT}, and the drain terminals are connected to one another; consequently, the first and second sum transistors Tₛ₁, Tₛ₂ concur to form, respectively, the aforementioned first and second current mirrors. The output resistor R_{OUT} is instead connected between ground and the drain terminals of the first and second sum transistors Tₛ₁, Tₛ₂.

The current output stage 8 comprises a third sum transistor Tₛ₃ and a fourth sum transistor Tₛ₄, both of a P-channel MOS type. The source terminals of said third and fourth sum transistors Tₛ₃, Tₛ₄ are connected to the supply terminal N_{DD}, whilst the gate terminals are connected, respectively, to the node N_{PTAT} and to the node N_{NTAT}, and the drain terminals are connected to one another and define an output node N_{OUT}. Consequently, the third and fourth sum transistors Tₛ₃, Tₛ₄ concur to form, respectively, the aforementioned first and second current mirrors.

In greater detail, the first, second, third and fourth biasing transistors T₁-T₄ are the same (but for the inevitable tolerances) and hence are characterized by one and the same aspect ratio W/L, which as is known indicates, given a generic MOS transistor, the ratio between the width and the length of the corresponding channel. Instead, the first, second, third, and fourth sum transistors Tₛ₁-Tₛ₄ are such that the aspect ratios are, respectively, γ·W/L, α·W/L, δ·W/L, and ε·W/L, where α, ε, γ, δ are mirror ratios, described hereinafter.

Operatively, it may be shown that, when the supply voltage V_{DD} is present on the supply terminal N_{DD}, in the collector terminal of the second bipolar transistor T_{bjt2} there circulates a current I_{C2}, which is equal to the current that circulates in the first biasing transistor T₁. Said current I_{C2} is hence equal to the sum of the currents I_{C1}, I_{B1} and I_{B2}, which are the currents that circulate, respectively, in the collector terminal of the first bipolar transistor T_{bjt1}, in the base terminal of the first bipolar transistor T_{bjt1}, and in the base terminal of the second bipolar transistor T_{bjt2}. Said current I_{C2} functions as current I_{PTAT}, which is substantially independent of the supply voltage V_{DD}. In fact, assuming that the first and second bipolar transistors T_{bjt1}, T_{bjt2} have respective parameters 13 high, and hence assuming that the currents I_{B1} and I_{B2} are negligible as compared to the current I_{PTAT} itself, the current I_{PTAT} is equal to the current that flows in the emitter terminal of the second bipolar transistor T_{bjt2}. Consequently, we have

$${I}_{PTAT} = \frac{{V}_{be 1} - {V}_{be 2}}{{R}_{rA}} = \frac{1}{{R}_{rA}} \cdot \frac{kT}{q} \cdot ln ( \frac{{A}_{2}}{{A}_{1}} ) \qquad ( 1 )$$

where R_{rA} is the resistance of the first resistor R_{A}, V_{be1} is the voltage present between the base terminal and the emitter terminal of the first bipolar transistor T_{bjt1}, V_{be2} is the voltage present between the base terminal and the emitter terminal of the second bipolar transistor T_{bjt2}, q is the charge of the electron, k is the Boltzmann constant, T is the temperature expressed in Kelvin, and A₁ and A₂ are, respectively, the areas of the base-emitter junctions of the first and second bipolar transistors T_{bjt1}, T_{bjt2}, which are referred to for reasons of brevity also as the areas of the first and second bipolar transistors T_{bjt1}, T_{bjt2}, and for which the relation A₂>A₁ applies.

A voltage V_{be3}, i.e., a voltage equal to the base-emitter voltage of the third bipolar transistor T_{bjt3}, is set up across the second resistor R_{B}. Said voltage V_{be3} is imposed on the second resistor R_{B} by the feedback loop defined by the third bipolar transistor T_{bjt3} and by the fifth biasing transistor T₅. In this way, the voltage across the second resistor R_{B} is substantially independent of the voltage V_{GS} present between the gate terminals and source terminals of the third and fourth biasing transistors T₃, T₄. Consequently, the voltage across the second resistor R_{B} is substantially independent of the supply voltage V_{DD}. In addition, it may be shown that in the fourth and fifth biasing transistors T₄, T₅ there circulates a current that functions as current I_{NTAT}, which is substantially independent of the supply voltage V_{DD}. In fact, assuming that the third bipolar transistor T_{bjt3} has a parameter 13 high, and hence that the current I_{B3} circulating in the base terminal of the third bipolar transistor T_{bjt3} is negligible as compared to the current I_{NTAT}, the current I_{NTAT} is given by the equation

$${I}_{NTAT} = \frac{{V}_{be 3}}{{R}_{rB}} \qquad ( 2 )$$

where R_{rB} is the value of resistance of the second resistor R_{B}.

The currents I_{PTAT} and I_{NTAT} are then added up inside the voltage output stage 6 and the current output stage 8, respectively, with the mirror ratios γ and α, and δ and ε.

It follows that, on the output resistor R_{OUT} of the voltage output stage 6, there is a reference voltage V_{REF}

V_{REF}=(αI_{NTAT}+γI_{PTAT})·R_{rOUT} (3)

where R_{rOUT} is the resistance of the output resistor R_{OUT}.

Likewise, by connecting a hypothetical load to the output node N_{OUT}, the current output stage 8 supplies, on said hypothetical load, a reference current I_{REF} of

I_{REF}=εI_{NTAT}+δI_{PTAT} (4)

As mentioned previously, the temperature coefficients of the currents I_{PTAT} and I_{NTAT} are, respectively, positive and negative, as emerges from Eqs. (1) and (2). In fact, the current I_{PTAT} is directly proportional to the temperature T because the difference V_{be1}−V_{be2} is in turn directly proportional to the temperature T, given that the relation A₂>A₁ applies. Instead, the behaviour of the current I_{NTAT} with respect to the temperature T is determined by the voltage V_{be3}, which, as is known, varies with the temperature with a coefficient of approximately −2 mV/°K.

It follows that, on the basis of Eqs. (3) and (4), it is possible to determine appropriate values of the mirror ratios α, ε, γ, δ such that the reference voltage V_{REF} and the reference current I_{REF} are, to a first approximation, constant with respect to the temperature T.

In order to enable optimal operation of the voltage and current generator circuit 1, and, in particular, in order to enable the operation described previously, recourse is usually had to a first start-up circuit and a second start-up circuit (which are not shown), connected, respectively, to the first self-biasing circuit 2 and the second self-biasing circuit 4. In particular, the first and second start-up circuits perform the function of biasing the first self-biasing circuit 2 and the second self-biasing circuit 4 in respective points of equilibrium such that Eqs. (1) and (2), and hence also Eqs. (3) and (4), yield non-zero results.

In greater detail, it may be shown that the first and second self-biasing circuits 2, 4 each have a pair of possible points of equilibrium. In particular, the first self-biasing circuit 2 has a respective useful point of equilibrium where the difference V_{be1}−V_{be2} is non-zero, and a respective zero point of equilibrium where the difference V_{be1}−V_{be2} is zero. Likewise, the second self-biasing circuit 4 has a respective useful point of equilibrium where the voltage V_{be3} is non-zero, and a respective zero point of equilibrium where the voltage V_{be3} is zero.

Assuming connection of the supply terminal N_{DD} to the supply voltage V_{DD} at an instant t₀, and assuming that for t<t₀ the voltage and current generator circuit 1 has not been supplied, the first and second self-biasing circuits 2, 4 are biased, in the absence of start-up circuits, in the respective useful point of equilibrium or else in the respective zero point of equilibrium, in a way that is in itself not predictable. The function of the first and second start-up circuits is precisely that of enabling, subsequent to the instant t₀, biasing of the first and second self-biasing circuits 2, 4 in the respective useful points of equilibrium. This done, the first and second start-up circuits turn off, without any longer interfering with operation of the voltage and current generator circuit 1.

Examples of start-up circuits are shown and described in “Low power startup circuits for voltage and current reference with zero steady state current”, International Symposium on Low Power Electronics and Design 2003, Aug. 25-27, Seoul, Korea. However, there is no further description of any start-up circuit herein in so far as the present invention is irrespective of the details of implementation of the start-up circuits themselves.

Thanks to the use described of the currents I_{PTAT} and I_{NTAT}, the voltage and current generator circuit 1 enables electrical quantities to be obtained that have a high stability in regard to temperature shifts. However, since the voltage and current generator circuit 1 comprises two self-biasing circuits, it entails the use of two start-up circuits and hence is characterized by a high circuit complexity, a considerable current consumption, and a considerable occupation of area. In particular, the latter characteristic is due not only to the presence of the third bipolar transistor T_{bjt3} but also to the presence of the third and fourth biasing transistors T₃, T₄, which usually have a large area in order to enable better mirroring the current I_{NTAT}. In addition, the presence of two self-biasing circuits causes the voltage and current generator circuit 1 to be sensitive to the inevitable tolerances introduced by technological processes that enable formation of the first and second self-biasing circuits. Consequently, the performance of the voltage and current generator circuit 1 can be inferior to what may be theoretically expected on account of process asymmetries in the formation of components belonging to different self-biasing circuits, such as, for example, the first and third bipolar transistors T_{bjt1}, T_{bjt3}.

### SUMMARY OF THE INVENTION

An aim of the present invention is to provide a circuit for generating a reference electrical quantity that will enable at least partial solution of the drawbacks of the known art.

According to at least one embodiment, there is provided a circuit for generating a reference electrical quantity, comprising a first bipolar transistor and a second bipolar transistor, the emitter terminal of the first bipolar transistor being connected to a first line at reference potential, the base terminals of the first and second bipolar transistors being connected to one another and to a common node a first resistor, connected between the emitter terminal of the second bipolar transistor and the first line at reference potential a first mirror circui, connected between a second line at reference potential and the first and second bipolar transistors and configured for receiving a first current which is a function of the current in the first resistor, and generating a first mirrored current a second mirror circuit, configured for receiving a second current and generating a second mirrored current and a first output stage, configured for generating the reference electrical quantity as a function of said first and second mirrored currents, and a second resistor connected between the first line at reference potential and the common node, said second current being a function of the current in the second resistor.

According to another embodiment, the generator circuit further comprises a follower transistor of a MOS type, having a gate terminal connected to the collector terminal of the first bipolar transistor, and a first conduction terminal connected to the common node.

According to another embodiment, said first mirror circuit comprises a first biasing transistor and a second biasing transistor having respective control terminals connected to one another, said first biasing transistor moreover having a first conduction terminal and a second conduction terminal, connected, respectively, to the second line at reference potential and to the collector terminal of said first bipolar transistor, said second biasing transistor moreover having a first conduction terminal and a second conduction terminal, connected, respectively, to the second line at reference potential and to the collector terminal of said second bipolar transistor, said second biasing transistor being diode-connected, the second bipolar transistor being configured so as to supply the first current through its own collector terminal.

According to another embodiment, said second mirror circuit comprises a diode-connected mirror transistor having a first conduction terminal and a second conduction terminal, respectively connected to the second line at reference potential and to a second conduction terminal of the follower transistor, the follower transistor being configured so as to supply the second current through its own second conduction terminal.

According to another embodiment, said first mirror circuit further comprises a first sum transistor having a control terminal and a first conduction terminal and a second conduction terminal, respectively connected to the control terminal of said second biasing transistor, to the second line at reference potential and to an output resistor, and said second mirror circuit further comprises a second sum transistor having a control terminal and a first conduction terminal and a second conduction terminal, respectively connected to the control terminal of said mirror transistor, to the second line at reference potential, and to said output resistor, in such a way that, in use, said first and second mirrored currents flow, respectively, through said first and second sum transistors.

According to another embodiment, said second biasing transistor and said first sum transistor have respective dimensions such as to define a first mirror ratio, and wherein said mirror transistor and said second sum transistor have respective dimensions such as to define a second mirror ratio.

According to another embodiment, said first and second bipolar transistors have, respectively, a first area and a second area, said first and second resistors having, respectively, a first resistance and a second resistance, said first and second resistances, said first and second areas, and said first and second mirror ratios being such as to reduce possible variations of a voltage present on said output resistor due to variations of said first and second currents caused by temperature shifts.

According to another embodiment, said first mirror circuit further comprises a third sum transistor having a control terminal and a first conduction terminal and a second conduction terminal, respectively connected to the control terminal of said second biasing transistor, to the second line at reference potential, and to an output node, and said second mirror circuit further comprises a fourth sum transistor having a control terminal and a first conduction terminal and a second conduction terminal, respectively connected to the control terminal of said mirror transistor, to the second line at reference potential, and to said output node, in such a way that, in use, a third mirrored current and a fourth mirrored current flow, respectively, through said third and fourth sum transistors.

According to another embodiment, said second biasing transistor and said third sum transistor have respective dimensions such as to define a third mirror ratio, and wherein said mirror transistor and said fourth sum transistor have respective dimensions such as to define a fourth mirror ratio.

According to another embodiment, said first and second resistances, said first and second areas, and said third and fourth mirror ratios are such as to reduce possible variations of a current supplied to said output node due to variations of said first and second currents caused by temperature shifts.

According to another embodiment, the generator circuit further comprises at least one from among: a first additional transistor connected in series to said first biasing transistor, a second additional transistor connected in series to said first sum transistor, a third additional transistor connected in series to said second sum transistor, a fourth additional transistor connected in series to said third sum transistor, and a fifth additional transistor connected in series to said fourth sum transistor.

According to another embodiment, said second area is greater than said first area.

According to another embodiment, said first mirror circuit further comprises a third sum transistor having a control terminal and a first conduction terminal and a second conduction terminal, respectively connected to the control terminal of said second biasing transistor, to the second line at reference potential and to an output node, and said second mirror circuit further comprises a fourth sum transistor having a control terminal and a first conduction terminal and a second conduction terminal, connected, respectively, to the control terminal of said mirror transistor, to the second line at reference potential, and to said output node in such a way that, in use, a first mirrored current and a second mirrored current flow, respectively, through said third and fourth sum transistors.

According to another embodiment, there is provided a method for generating a reference electrical quantity, comprising the steps of providing a first bipolar transistor and a second bipolar transistor receiving a first current and generating a first mirrored current, said first current being a function of the current in a first resistor, connected to the emitter terminal of the second bipolar transistor and to a first line at reference potential, the emitter terminal of the first bipolar transistor being connected to the first line at reference potential, the base terminals of the first and second bipolar transistors being connected to one another and to a common node receiving a second current and generating a second mirrored current and generating the reference electrical quantity as a function of said first and second mirrored currents wherein said step of receiving a second current comprises receiving the current in a second resistor connected between the first line at reference potential and the common node.

### BRIEF DESCRIPTION OF THE DRAWINGS

For a better understanding of the invention, embodiments thereof are now described, purely by way of non-limiting example and with reference to the attached drawings, wherein:

FIG. 1 shows a circuit diagram of a circuit for generating a reference current and a reference voltage according to the known art; and

FIGS. 2 and 3 show circuit diagrams of embodiments of the present circuit for generating a reference electrical quantity.

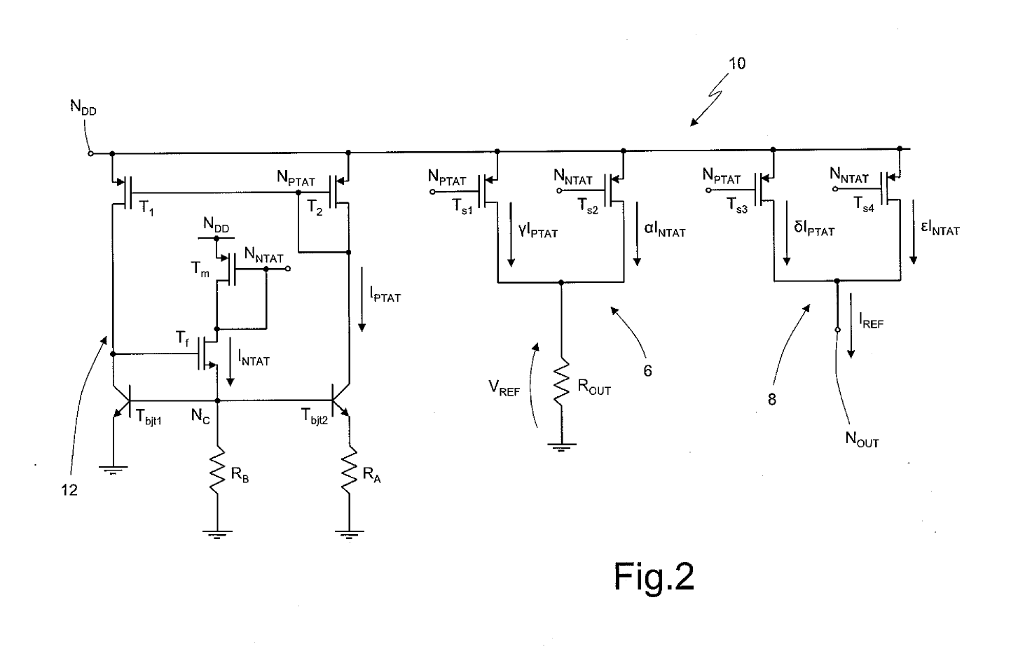

FIG. 2 shows a circuit for generating a reference electrical quantity, designated as a whole by 10, and referred to hereinafter, for reasons of brevity, as the source circuit 10.

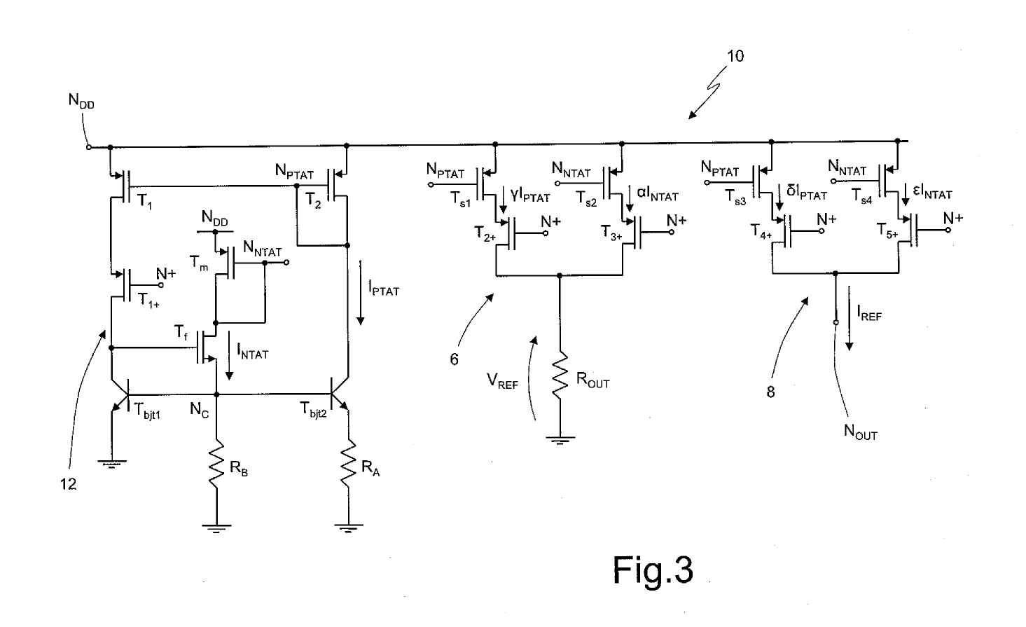

### DETAILED DESCRIPTION

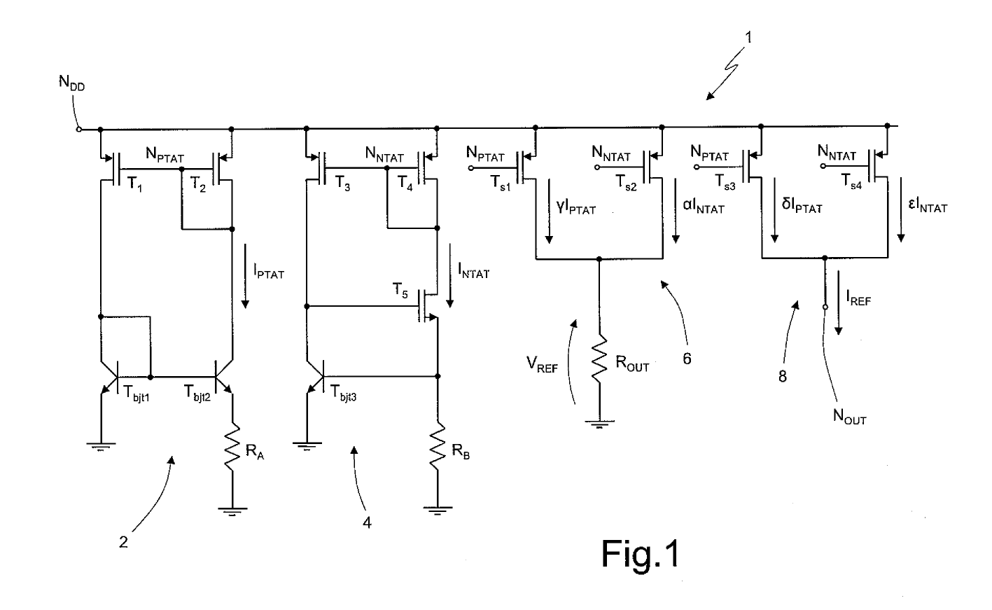

The source circuit 10 is described in what follows, the present description being limited to the differences alone of the source circuit 10 with respect to the voltage and current generator circuit 1 illustrated in FIG. 1. In addition, components of the source circuit 10 that are already present in the voltage and current generator circuit 1 are designated in the same way, except where otherwise specified.

In detail, the source circuit 10 comprises the first self-biasing circuit, here designated by 12, but does not have the second self-biasing circuit 4. In addition, the source circuit 10 comprises at least one between the voltage output stage 6 and the current output stage 8; in this connection, described by way of example in what follows is one embodiment, present in which are both the voltage output stage 6 and the current output stage 8.

In greater detail, the first self-biasing circuit 12 comprises the first and second resistors R_{A}, R_{B}, the first and second biasing transistors T₁, T₂, and the first and second bipolar transistors T_{bjt1}, T_{bjt2}. In addition, the first self-biasing circuit 12 comprises a mirror transistor Tₘ and a follower transistor T_{f}.

In detail, the second resistor R_{B} is connected between ground and the base terminals of the first and second bipolar transistors T_{bjt1}, T_{bjt2}, which define a common node N_{C}.

The mirror transistor Tₘ is a P-channel MOS transistor. In particular, the source terminal of the mirror transistor Tₘ is connected to the supply terminal N_{DD}, whilst the gate terminal defines the node N_{NTAT}, and hence is connected to the gate terminals of the second and fourth sum transistors Tₛ₂, Tₛ₄. In addition, the mirror transistor Tₘ is diode-connected; i.e., its drain terminal is connected to its gate terminal.

The follower transistor T_{f} is an N-channel MOS transistor. In particular, the drain terminal of the follower transistor T_{f} is connected to the drain terminal (and hence also to the gate terminal) of the mirror transistor Tₘ. The gate terminal of the follower transistor T_{f} is connected to the drain terminal of the first biasing transistor T₁, and hence also to the collector terminal of the first bipolar transistor T_{bjt1}. The source terminal of the follower transistor T_{f} is instead connected to the common node N_{C}, and hence to the base terminals of the first and second bipolar transistors T_{bjt1}, T_{bjt2}, and to the second resistor R_{B}.

As regards the resistances R_{rA}, R_{rB}, R_{rouT} of the first and second resistors R_{A}, R_{B} and of the output resistor R_{OUT}, the following relations apply:

R_{rB}=n·R_{A}, R_{rOUT}=m·R_{rA} (5)

with n and m not necessarily integers.

Operatively, the current that flows in the follower transistor T_{f} functions as current I_{NTAT}, which is mirrored by the mirror transistor Tₘ and by the second and fourth sum transistors Tₛ₂, Tₛ₄. In practice, the mirror transistor Tₘ functions as reading branch of the second current mirror, performing the function that in the voltage and current generator circuit 1 was performed by the fourth biasing transistor T₄.

In addition, the follower transistor T_{f} functions as source follower since the voltage on its own gate terminal follows the voltage on its own source terminal; consequently, in the small-signal regime, the first bipolar transistor T_{bjt1} is diode-connected. In other words, the follower transistor T_{f} enables current uncoupling of the base terminals of the first and second bipolar transistors T_{bjt1}, T_{bjt2} from the current that flows in the first biasing transistor T₁. Again, in other words, thanks to the presence of the follower transistor T_{f}, as well as of the first and second biasing transistors T₁, T₂, the currents I_{C1} and I_{C2} that flow in the collector terminals of the first and second bipolar transistors T_{bjt1} T_{bjt2} are the same, notwithstanding the fact that the second resistor R_{B} is connected to the base terminals of the first and second bipolar transistors T_{bjt1}, T_{bjt2} themselves. In fact, the current I_{NTAT} that flows in the follower transistor T_{f} is equal to the sum of the currents I_{RB}, I_{B1}, I_{B2} that flow in the second resistor R_{B} and in the base terminals of the first and second bipolar transistors T_{bjt1}, T_{bjt2}, respectively.

On the basis of what has been described, it follows that once again Eq. (1) applies, and moreover, assuming that the currents I_{B1}, I_{B2} are negligible as compared to the current I_{RB}, the current I_{NTAT} is equal to the current I_{RB}.

Consequently, the following equation applies:

$${I}_{NTAT} = \frac{{V}_{be 1}}{{R}_{rB}} = \frac{{V}_{be 1}}{n \cdot {R}_{rA}} \qquad ( 6 )$$

In particular, the resistance R_{rB} can be sized in such a way that the currents I_{B1}, I_{B2} are negligible as compared to the current I_{RB} also in the case where the first and second bipolar transistors T_{bjt1}, T_{bjt2} have parameters 13 that are not particularly high.

On the basis of Eqs. (1) and (6), we moreover have

$$\begin{matrix}\begin{matrix}{V}_{REF} = ( α {I}_{NTAT} + γ {I}_{PTAT} ) \cdot {R}_{rOUT} \\ = m \cdot ( \frac{α}{n} \cdot {V}_{be 1} + γ \cdot \frac{kT}{q} \cdot ln ( \frac{{A}_{2}}{{A}_{1}} ) )\end{matrix} & ( 7 ) \\ \begin{matrix}{I}_{REF} = ɛ {I}_{NTAT} + δ {I}_{PTAT} \\ = \frac{1}{{R}_{rA}} \cdot ( \frac{ɛ}{n} \cdot {V}_{be 1} + δ \cdot \frac{kT}{q} \cdot ln ( \frac{{A}_{2}}{{A}_{1}} ) )\end{matrix} & ( 8 )\end{matrix}$$

In practice, the reference voltage V_{REF} and the reference current I_{REF} depend upon the temperature T both because the temperature T itself appears explicitly in Eqs. (7) and (8) and because, as is known, the voltage V_{be1} varies with the temperature with a coefficient of approximately −2 mV/K. In practice, it is possible to size the source circuit 10 in such a way that the reference voltage V_{REF} and the reference current I_{REF} are constant with respect to possible temperature shifts; i.e., they have a zero temperature coefficient. For this purpose, the degrees of freedom represented by the mirror ratios α, ε, γ, δ, as well as by the coefficient n and by the areas A₁ and A₂ of the first and second bipolar transistors T_{bjt1}, T_{bjt2} are available. For example, it is possible to size appropriately the coefficient n, the mirror ratios α and γ, and the areas A₁ and A₂ of the first and second bipolar transistors T_{bjt1}, T_{bjt2} in such a way as to annul the temperature coefficient of the reference voltage V_{REF}. Next, it is possible to size the mirror ratios ε and δ appropriately in such a way as to annul the temperature coefficient of the reference current I_{REF}.

As regards, in particular, the reference voltage V_{REF}, it does not depend upon the absolute value of resistance of any resistor of the source circuit 10, but rather depends upon the ratios between resistance values; consequently, it does not call for operations of calibration, nor is it affected by possible variations occurring during the technological processes of formation of the source circuit 10. In addition, the reference voltage V_{REF} can be established as desired by appropriately choosing the coefficient m irrespective of the choice of the mirror ratios α, ε, γ, δ, of the coefficient n and of the areas A₁, A₂. In particular, the reference voltage V_{REF} can assume an arbitrary value comprised between ground and V_{DD}−|V_{DSx}|, where:

−V_{DD}>V_{be1}+|V_{DS1}|+|V_{GSth}|, where V_{DS1} is a (negative) voltage between the drain and source terminals of the first biasing transistor T₁ such as to keep in saturation the first biasing transistor T₁, whilst V_{GSth} is a threshold voltage of the follower transistor T_{f}; and

−V_{DSX} is a (negative) voltage between the drain and source terminals of the first and second sum transistors Tₛ₁, Tₛ₂ such as to keep said first and second sum transistors Tₛ₁, Tₛ₂ in saturation.

As regards, instead, the reference current I_{REF}, this depends upon the absolute value of the resistance R_{rA}, which may depend upon the temperature. However, it is possible to determine the values of the mirror ratios ε, δ and the value of the coefficient n so as to compensate for the dependence upon the temperature of the resistance R_{rA}. In addition, to eliminate the dependence of the reference current I_{REF} upon possible tolerances on the absolute value of the resistance R_{rA}, and in particular upon a deviation between the nominal value and the effective value of the resistance R_{rA}, it is possible to determine the values of the mirror ratios ε and δ, and the value of the coefficient n as a function of said tolerances, after prior measurement of the effective value of the resistance R_{rA}.

It should be moreover noted that, even though the possibility has been described of determining the mirror ratios α, ε, γ, δ and the coefficient n in such a way that the reference voltage V_{REF} and the reference current I_{REF} will have a zero temperature coefficient, it is likewise possible to determine the mirror ratios α, ε, γ, δ and the coefficient n in such a way that the reference voltage V_{REF} and the reference current I_{REF} have respective arbitrary temperature coefficients. In other words, it is possible to size the source circuit 10 in such a way that the reference voltage V_{REF} and the reference current I_{REF} have a desired dependence upon temperature.

Purely by way of example, it is possible to assume A₂/A₁=2, n=m=1, R_{rA}=10 kΩ, α=ε=1, γ=δ=33.4.

As illustrated in FIG. 3, it is moreover possible to insert one or more additional transistors. Said additional transistors can be of a P-channel MOS type and have the respective gate terminals connected to an additional N+ terminal, which is in turn biased at a cascode voltage V+ by means of an appropriate additional biasing circuit (not shown).

For example, it is possible to insert a first additional transistor T₁₊ between the first biasing transistor T₁ and the first bipolar transistor T_{bjt1}. Said first additional transistor has its source and drain terminals connected, respectively, to the drain terminal of the first biasing transistor T₁ and to the collector terminal of the first bipolar transistor T_{bjt1}.

The presence of the first additional transistor T₁₊ enables optimization of the performance of the first current mirror, and hence of the first and second biasing transistors T₁, T₂. In fact, designating by V_{DS2} the voltage between the drain and source terminals of the second biasing transistor T₂, in a way in itself known it is possible to design the additional biasing circuit in such a way that the cascode voltage V+ is a function of the supply voltage V_{DD}. In particular, the cascode voltage V+ can be a function of the supply voltage V_{DD} according to a law such that the voltages V_{DS1}, V_{DS2} are the same, or at least have an equal dependence upon the supply voltage V_{DD}. In this way, the first current mirror is of a cascode type and hence has improved behavior with respect to variations in the supply voltage V_{DD}.

In a similar way, a second additional transistor T₂₊ and a third additional transistor T₃₊ can be inserted between the output resistor R_{OUT} and, respectively, the first and second sum transistors Tₛ₁, Tₛ₂. Again, a fourth additional transistor T₄₊ and a fifth additional transistor T₅₊ can be inserted between the output node N_{OUT} and, respectively, the third and fourth sum transistors Tₛ₃, Tₛ₄. In practice, the second, third, fourth, and fifth additional transistors T₂₊-T₅₊ are arranged in series with the first, second, third, and fourth sum transistors Tₛ₁-Tₛ₄, respectively.

The advantages that the source circuit 10 affords emerge clearly from the foregoing discussion. In particular, the source circuit 10 enables the reference voltage V_{REF} and/or the reference current I_{REF} to be obtained by using just one self-biasing circuit, with evident advantages in terms of reduction of current consumption, reduction of circuit complexity, and higher integrability. The latter advantage is due to the reduction of the area occupied, obtained precisely by means of elimination of the second self-biasing circuit 4. In addition, the presence of just one self-biasing circuit involves the use of just one start-up circuit. In this connection, the source circuit 10 can be connected to a start-up circuit of a known type.

As further advantage, the reference voltage V_{REF} supplied by the source circuit 10 does not depend upon the absolute value of resistance of any resistor of the source circuit 10, and can moreover be established as desired by an appropriate choice of the coefficient m, irrespective of the choice of the mirror ratios α, ε, γ, δ and of the coefficient n.

Finally, it is evident that modifications and variations may be made to the source circuit 10 described and illustrated herein, without thereby departing from the sphere of protection of the present invention, as defined in the annexed claims.

For example, instead of the output resistor R_{OUT} it is possible to use a resistive divider, i.e., a plurality of resistors connected in series, in order to generate a plurality of different reference voltages.

In addition, instead of the first and second biasing transistors T₁, T₂, and of the first and third sum transistors Tₛ₁, Tₛ₃, it is possible to use different circuits, provided that they enable mirroring of the current I_{PTAT}. Likewise, instead of the mirror transistor Tₘ and the second and fourth sum transistors Tₛ₂, Tₛ₄, it is possible to use different circuits, provided that they enable mirroring of the current I_{NTAT}.

Finally, the first and second biasing transistors T₁, T₂, as well as the first, second, third, and fourth sum transistors Tₛ₁-Tₛ₄ can be of a type different from what has been described and illustrated.

Such alterations, modifications, and improvements are intended to be part of this disclosure, and are intended to be within the spirit and the scope of the present invention. Accordingly, the foregoing description is by way of example only and is not intended to be limiting. The present invention is limited only as defined in the following claims and the equivalents thereto.

What is claimed is:

1. A circuit for generating a reference electrical quantity, comprising:
a first bipolar transistor and a second bipolar transistor, the emitter terminal of the first bipolar transistor being connected to a first line at reference potential, the base terminals of the first and second bipolar transistors being connected to one another and to a common node;
a first resistor, connected between the emitter terminal of the second bipolar transistor and the first line at reference potential;
a first mirror circuit, connected between a second line at reference potential (N_{DD}) and the first and second bipolar transistors and configured for receiving a first current, which is a function of the current in the first resistor, and generating a first mirrored current;
a second mirror circuit, configured for receiving a second current (I_{NTAT}) and generating a second mirrored current; and
a first output stage, configured for generating the reference electrical quantity as a function of said first and second mirrored currents; and
a second resistor connected between the first line at reference potential and the common node, said second current being a function of the current in the second resistor.

2. The generator circuit according to claim 1, further comprising a follower transistor of a MOS type, having a gate terminal connected to the collector terminal of the first bipolar transistor, and a first conduction terminal connected to the common node.

3. The generator circuit according to claim 2, wherein said first mirror circuit comprises a first biasing transistor and a second biasing transistor having respective control terminals connected to one another, said first biasing transistor moreover having a first conduction terminal and a second conduction terminal, connected, respectively, to the second line at reference potential and to the collector terminal of said first bipolar transistor, said second biasing transistor moreover having a first conduction terminal and a second conduction terminal, connected, respectively, to the second line at reference potential and to the collector terminal of said second bipolar transistor, said second biasing transistor being diode-connected, the second bipolar transistor being configured so as to supply the first current through its own collector terminal.

4. The generator circuit according to claim 3, wherein said second mirror circuit comprises a diode-connected mirror transistor having a first conduction terminal and a second conduction terminal, respectively connected to the second line at reference potential and to a second conduction terminal of the follower transistor, the follower transistor being configured so as to supply the second current through its own second conduction terminal.

5. The generator circuit according to claim 4, wherein said first mirror circuit further comprises a first sum transistor having a control terminal and a first conduction terminal and a second conduction terminal, respectively connected to the control terminal of said second biasing transistor, to the second line at reference potential and to an output resistor, and said second mirror circuit further comprises a second sum transistor having a control terminal and a first conduction terminal and a second conduction terminal, respectively connected to the control terminal of said mirror transistor, to the second line at reference potential, and to said output resistor, in such a way that, in use, said first and second mirrored currents flow, respectively, through said first and second sum transistors (Tₛ₁, T₅₂).

6. The generator circuit according to claim 5, wherein said second biasing transistor and said first sum transistor have respective dimensions such as to define a first mirror ratio, and wherein said mirror transistor and said second sum transistor have respective dimensions such as to define a second mirror ratio.

7. The generator circuit according to claim 6, wherein said first and second bipolar transistors have, respectively, a first area and a second area, said first and second resistors having, respectively, a first resistance and a second resistance, said first and second resistances, said first and second areas, and said first and second mirror ratios being such as to reduce possible variations of a voltage present on said output resistor due to variations of said first and second currents caused by temperature shifts.

8. The generator circuit according to claim 7, wherein said first mirror circuit further comprises a third sum transistor having a control terminal and a first conduction terminal and a second conduction terminal, respectively connected to the control terminal of said second biasing transistor, to the second line at reference potential, and to an output node, and said second mirror circuit further comprises a fourth sum transistor having a control terminal and a first conduction terminal and a second conduction terminal, respectively connected to the control terminal of said mirror transistor, to the second line at reference potential, and to said output node, in such a way that, in use, a third mirrored current and a fourth mirrored current flow, respectively, through said third and fourth sum transistors.

9. The generator circuit according to claim 8, wherein said second biasing transistor and said third sum transistor have respective dimensions such as to define a third mirror ratio, and wherein said mirror transistor and said fourth sum transistor have respective dimensions such as to define a fourth mirror ratio.

10. The generator circuit according to claim 9, wherein said first and second resistances, said first and second areas, and said third and fourth mirror ratios are such as to reduce possible variations of a current supplied to said output node due to variations of said first and second currents caused by temperature shifts.

11. The generator circuit according to claim 8, further comprising at least one from among: a first additional transistor connected in series to said first biasing transistor, a second additional transistor connected in series to said first sum transistor, a third additional transistor connected in series to said second sum transistor, a fourth additional transistor connected in series to said third sum transistor, and a fifth additional transistor connected in series to said fourth sum transistor.

12. The generator circuit according to claim 7, wherein said second area is greater than said first area.

13. The generator circuit according to claim 4, wherein said first mirror circuit further comprises a third sum transistor having a control terminal and a first conduction terminal and a second conduction terminal, respectively connected to the control terminal of said second biasing transistor, to the second line at reference potential) and to an output node, and said second mirror circuit further comprises a fourth sum transistor having a control terminal and a first conduction terminal and a second conduction terminal, connected, respectively, to the control terminal of said mirror transistor, to the second line at reference potential, and to said output node in such a way that, in use, a first mirrored current) and a second mirrored current flow, respectively, through said third and fourth sum transistors.

14. A method for generating a reference electrical quantity, comprising the steps of:
providing a first bipolar transistor and a second bipolar transistor;
receiving a first current and generating a first mirrored current, said first current being a function of the current in a first resistor, connected to the emitter terminal of the second bipolar transistor and to a first line at reference potential, the emitter terminal of the first bipolar transistor being connected to the first line at reference potential, the base terminals of the first and second bipolar transistors being connected to one another and to a common node;
receiving a second current and generating a second mirrored current; and
generating the reference electrical quantity as a function of said first and second mirrored currents;
wherein said step of receiving a second current comprises receiving the current in a second resistor connected between the first line at reference potential and the common node.
